(19) United States
(12) Patent Application Publication
(10) Pub. No.: US 2007/0032959 A1
(43) Pub. Date: Feb. 8, 2007

(54) Emission of seismic vibrations by a train consisting of vibrator trucks

(76) Inventors: Rene Jaulin, Nantes (FR); Pierre Baliguet, Nantes (FR)

Correspondence Address: Blakely Sokoloff;Taylor & Zafman, 7th Floor, 12400 Wilshire Boulevard, Los Angeles, CA, 90025, US

(21) Appl. No.: 10/558,314

(22) PCT Filed: May 26, 2004
(86) PCT No.: PCT/FR04/01304

§ 371 Date: Nov. 22, 2005

(30) Foreign Application Priority Data
May 28, 2003 (FR) 03.06493

(51) Int. Cl. G01V 1/28

(52) U.S. Cl. 702/17

(57) ABSTRACT

The invention relates to a mobile device for emitting seismic vibrations into the ground in order to collect geophysical data, said device comprising at least two mobile platforms, each provided with a vibrating pad that vibrates in such a way as to propagate seismic waves in the ground when said vibrating pad is brought into contact with the ground at a desired spot. The inventive device is characterised in that the mobile platforms are interconnected in order to form a train of platforms in which the distance between the vibrating pads of said mobile platforms is controlled.

The invention relates to the operations of acquiring geophysical data on the ground mainly for the purpose of exploiting fields of hydrocarbons.

The invention relates more particularly to a device and a method for seismic emission by a wave generator through the ground.

In order to collect geophysical data, one or more seismic sources in contact with the ground are activated to propagate series of omnidirectional seismic waves. The series of waves reflected by the strata of the subsurface are then detected by sensors which generate a signal characterizing the reflection of the waves on the geological interfaces of the subsurface.

Said seismic sources may in particular consist of vibrators, the seismic emission by vibrator consisting in emitting into the ground series of waves for a dozen seconds and at a progressively variable frequency, between 10 hertz and 70 hertz for example.

For this purpose, mobile platforms (usually trucks called vibrator trucks) are used comprising a vibrator plate placed in contact with the ground by a system of hydraulic cylinders. When the vibrator truck reaches the vibration point, the operator lowers the vibrator plate to place it in contact with the ground, the whole weight of the vibrator truck then being pressed onto the vibrator plate. The seismic signal is then sent into the ground under the action of a piston which exerts an alternating force on the vibrator plate.

In what follows, the term vibrator truck will preferably be used in order to designate any mobile platform fitted with a vibrator plate for seismic emission by vibrator.

The emission device usually comprises a set of vibrators, that is to say several vibrator plates vibrating in phase. For this purpose, said emission device consists of a plurality of vibrator trucks (usually four or five). Said trucks are lined up depending on the interest of the geophysical profile to be characterized and are spaced out variably, usually 10 to 15 meters apart. In this way, the surface waves are attenuated and the volume waves emitted vertically are enhanced.

The set of vibrator trucks moves progressively along the profile, substantially a distance of 10 or 15 meters, in order to go and vibrate on a new position and obtain in consequence a high degree of multiple coverage.

An important constraint associated with the use of one or more seismic sources is the need to position the vibrators precisely and to know the exact location of each of them so that the exploitation of the data is reliable. The deployment of these vibrators on the ground is therefore an operation requiring great precision.

The vibrator trucks however represent a great mass and volume. It is therefore difficult to have a set of vibrators, and consequently their vibrator plates, stationed quickly and precisely. The seismic source, that is to say all the waves sent by the set of vibrators, then suffers from a large dispersion which causes a deformed image of the seismic results.

It is a conventionally known practice to locate and position the various vibrator plates by means of a radio positioning system, particularly with the aid of the Global Positioning System (GPS). The vibrator trucks in this case are fitted with a GPS positioning receiver which is used to locate them remotely thanks to the signals emitted by the geostationary satellites of the GPS system and the geographic computer data.

Only the mean positioning of all the vibrators is however taken into account for recording said location. The vibrators may be spaced irregularly and imprecisely relative to this mean point or centre of gravity. The precision of the positioning of all the vibrators is therefore not totally satisfactory and the dispersion of the seismic source may remain great.

In addition, the placing of a set of vibrator trucks for stationing the vibrator plates is carried out with a shift in time, each vehicle being positioned only when the vehicle in front of it has been precisely stationed at its plate stationing point. Consequently, the time the vibrator truck drivers need to partially improve the putting together of the plate stationing points, and thereby reduce the general area of installation of said plates, is great and counter to the necessary productivity. Data acquisition campaigns usually take a long time, and the costs associated with the immobilization of the equipment and with the labor are consequently usually very high.

A first object of the invention is to reduce the costs of geophysical data acquisition by reducing as much as possible the duration of the acquisition campaigns.

Another object of the invention is to provide a precise and grouped positioning of the various vibrator plates of the set of vibrators to concentrate and reduce the dispersion of the seismic source.

Accordingly, the invention proposes a mobile device for emitting seismic vibrations into the ground for the purpose of acquiring geophysical data comprising at least two mobile platforms, said mobile platforms each comprising a vibrator plate capable of vibrating for the propagation of seismic waves into the ground. When the vibrator plate is placed in contact with the ground at a desired stationing point, the weight of the mobile platform then presses on said vibrator plate. The characteristic of these mobile platforms is that they are interconnected for the formation of a train of platforms in which the distance between the vibrator plates of said mobile platforms is controlled.

The use of one or more trains consisting of interconnected platforms thus makes it possible to no longer waste the time that was conventionally necessary for putting the mobile platforms together before stopping them for stationing the vibrator plates.

In addition, the device according to the invention can be used to establish a known and stable distance between the vibrator plates and therefore to have a precise positioning of said plates relative to one another. It also minimizes the spacing between the vibrator plates and therefore concentrates the whole seismic source assembly.

The formation of said train of platforms is advantageously achieved by mechanically connecting the rear of one mobile platform to the front of another mobile platform, said mobile platforms thus being stationed in line one behind the other in the train of platforms.

The device that is the subject of the invention can be used to economize the employment of mobile platform drivers. Effectively it requires a single operator to drive it, said single operator being able to be, for example, the driver of the mobile platform leading the train of platforms.

A mechanical and electronic control is carried out remotely by the driver of the mobile platform leading the train on the platforms downstream of said leading platform. For this purpose, analogue or digital cables connect the various platforms forming said train of platforms and are used for the transmission of the control information between the leading platform and the platforms downstream of said leading platform.

According to a preferred embodiment of the invention, each of the mobile platforms of said train has its own power unit, said unit being suitable for providing its motorization and the driving of its vibrator plate.

According to a particular embodiment of the invention, the mobile platform leading said train has an internal combustion engine capable of motorizing the train of platforms and driving all the vibrator plates of the train, each of the mobile platforms other than that leading the train not requiring any power unit.

The mechanical connection between the rear of a first mobile platform to the front of a second mobile platform is advantageously fixed and rigid in the horizontal plane and it has a slight vertical movement. It is advantageously short in order to minimize the spacing between the vibrator plates of the platforms forming said train of platforms.

According to a possible embodiment of said mechanical connection, the latter consists of a connecting plate which comes between the rear part of said first platform and the front part of said second platform, said connecting plate being suitable for allowing a see-saw movement of said first and second platforms about the horizontal axis.

Said mechanical connection may also comprise at least one drawbar extending between the rear of a first mobile platform and the front of a second mobile platform. It may also comprise a triangular hitch tongue allowing a horizontal movement and defining thereby a turning angle between two successive platforms of the train of platforms.

The invention also proposes a method of emitting seismic vibrations into the ground in order to acquire geophysical data with the aid of a device of the aforementioned type, characterized by the following steps:
a) at least two mobile platforms are interconnected for the formation of a train of mobile platforms,
b) said train of platforms is driven to a desired stationing point,
c) the vibrator plates are lowered in order to place them in contact with the ground, the weight of said platforms pressing on said vibrator plates.
d) The vibrator plates are made to vibrate so that they transmit seismic waves into the ground.
e) The vibrator plates are raised.
f) Steps b to e are repeated as many times as necessary for the geophysical characterization of the ground being studied.

Other features, objectives and advantages of the invention will appear on reading the following detailed description with reference to the appended drawings, given as nonlimiting examples in which:

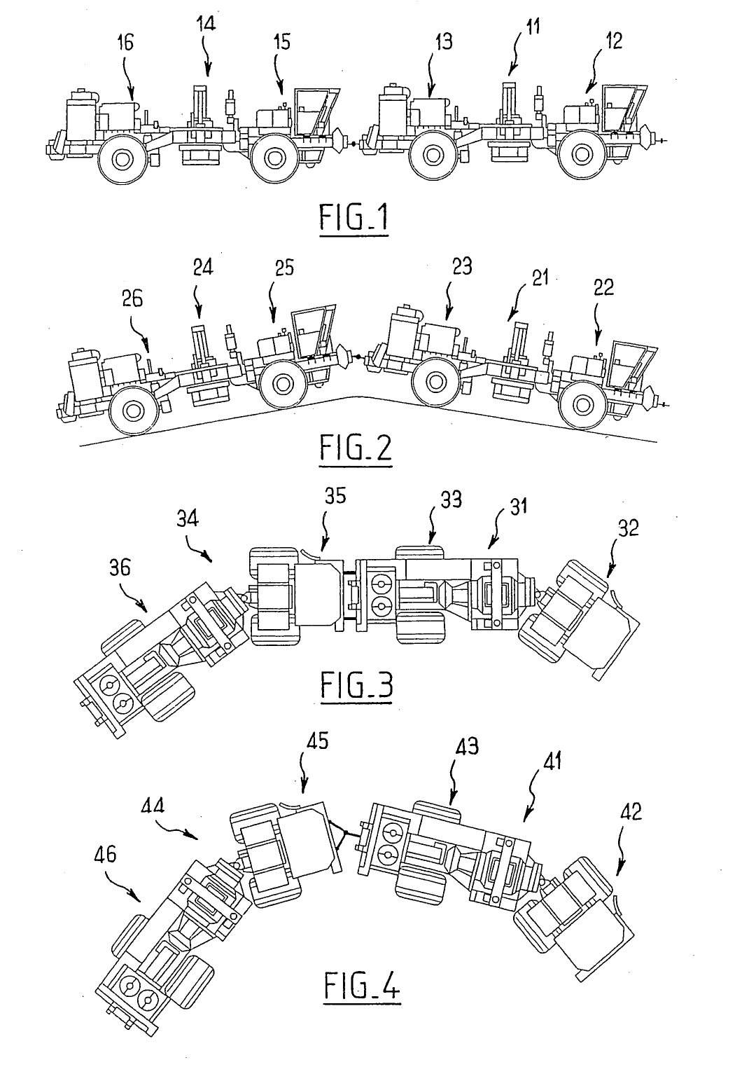

FIG. 1 represents a side view of two vibrator trucks interconnected to form a train of vibrator trucks stationed on flat ground;

FIG. 2 represents a side view of two vibrator trucks interconnected to form a train of vibrator trucks stationed on sloping ground;

FIG. 3 represents a top view of two vibrator trucks interconnected with the aid of two drawbars;

FIG. 4 represents a top view of two vibrator trucks interconnected by a triangular hitch tongue;

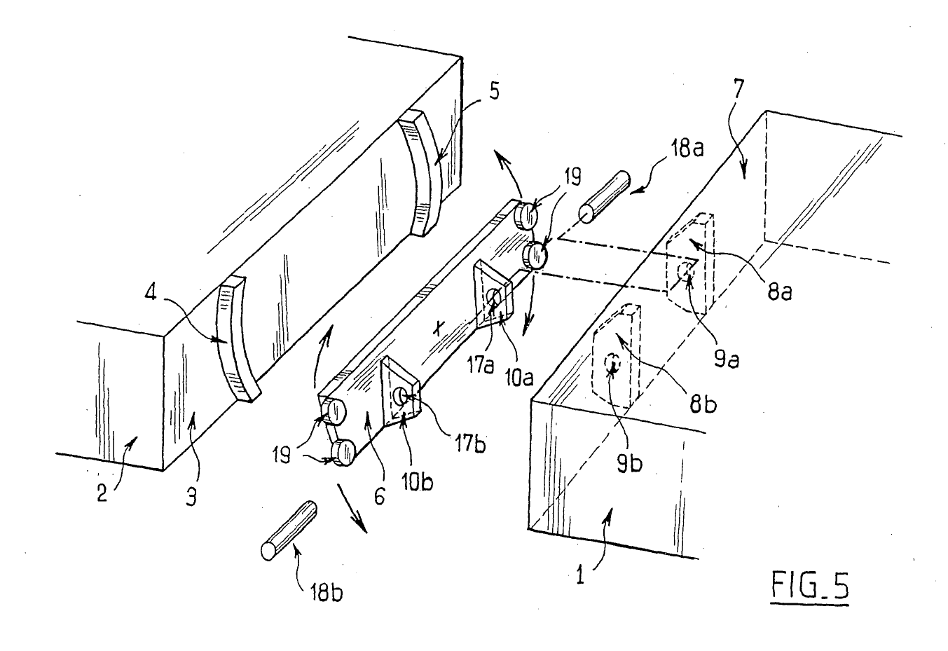

FIG. 5 represents a possible embodiment of the articulation between two vibrator trucks;

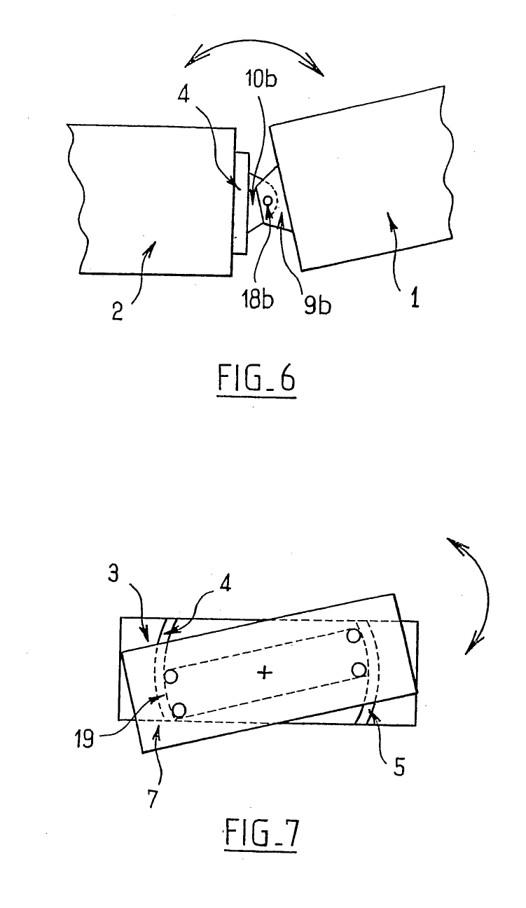

FIG. 6 represents a side view of said possible embodiment of the articulation between two vibrator trucks;

FIG. 7 represents a front view of said possible embodiment of the articulation between two vibrator trucks.

FIGS. 1 to 4 represent a train of vibrator trucks according to the invention. Said train of vibrator trucks consists, with reference respectively to FIGS. 1 to 4, of a first vibrator truck 11, 21, 31, 41 and a second vibrator truck 14, 24, 34, 44.

Each vibrator truck conventionally consists of a front part 12, 15; 22, 25; 32, 35; 42, 45 and a rear part 13, 16; 23, 26; 33, 36; 43, 46. Said front part essentially contains the driver position and the rear part, for its part, essentially contains the vibrator plate, the hydraulic circuits and the power unit.

Said front and rear parts are, as can be seen in the representations of FIGS. 3 and 4 from top views, mobile relative to one another so as to allow a turning angle between the front and rear parts of one and the same vibrator truck.

The rear part 13, 23, 33, 43 of a first vibrator truck 11, 21, 31, 41 is mechanically connected to the front part 15, 25, 35, 45 of a second vibrator truck 14, 24, 34, 44.

Naturally, the number of vibrator trucks interconnected in this way is not limited to two as is the case in FIGS. 1 to 4. It is thus possible to produce a train of vibrator trucks consisting of a number greater than or equal to two vibrator trucks. The leading vibrator truck is then connected via its rear part to the front part of a second vibrator truck. The last vibrator truck in line is the one connected via its front part to the rear part of the vibrator truck immediately preceding it. Finally, each intermediate vibrator truck between the leading vibrator truck and the one that is last in line is connected via its front part to the vibrator truck situated immediately upstream and via its rear part to the vibrator truck situated immediately downstream in said train of vibrator trucks.

According to a preferred embodiment of the invention, five vibrator trucks are connected in this way. Each vehicle being approximately 10 meters long, the train of vibrator trucks forms a line with a total length of approximately 50 meters. The seismic source then consists of five vibrator plates vibrating in phase and spaced precisely 10 meters from one another.

The mechanical connection between two vibrator trucks is advantageously short to limit the spacing between said vibrator trucks. Said connection is also advantageously robust to allow the connection of a plurality of vibrator trucks whose mass and volume are considerable.

The use of a train of vibrator trucks makes it possible to establish a known and stable distance between the vibrator plates of the different vibrator trucks forming said train. The vibrator trucks being interconnected and positioned in a known manner relative to one another, it is not necessary to put them together before they stop to station the vibrator plates. The awkward and time-consuming operation of positioning the vibrator trucks relative to one another is thus advantageously removed thanks to the device according to the invention.

The short mechanical connection between the various vibrator trucks also minimizes the spacing between the vibrator plates of the vibrator trucks and therefore concentrates the complete assembly of the seismic source. The dispersion of said seismic source is consequently limited and the quality of the geophysical data collected is enhanced.

According to a preferred embodiment of the invention, each vibrator truck conventionally has its own power unit suitable for providing its motorization and driving its vibrator plate.

A single operator, the driver of a vibrator truck then called the master vibrator, can be in charge of driving the train consisting of vibrator trucks.

Said operator is for example the driver of the first vibrator truck leading the train of platforms.

Because of the mechanical connection interlinking the vibrator trucks, he also drives the assembly of vibrator trucks, situated downstream of said master vibrator in the train of vibrator trucks, called slave vibrators.

Said driver of the master vibrator also advantageously has a remote mechanical and electronic control over the slave vibrators. The control is exerted thanks to a connection between the various vibrator trucks with the aid of analogue or digital cables. Said connection is used to upload the control information from the slave vibrators to the master vibrator and reciprocally to transmit the control information to the slave vibrators from the master vibrator.

The control relates to all the elements essential to the driving of the vehicles, to the supervision of the parameters for the correct operation of the equipment and to safety.

Advantageously, the operation of the electronics of the various vibrators does not require the intervention of the driver of the master vibrator during a day of geophysical data acquisition and only the function of lowering the plates is transmitted to the master vibrator.

The invention therefore proposes a train consisting of interconnected vibrator trucks for which only one driver is necessary. The device that is the subject of the invention thus saves labor costs.

According to a particular embodiment of the invention, the vibrators are motorized and their vibrator plates are driven, not individually by the power unit of each of the vibrator trucks, but by a single engine, of the internal combustion type for example.

This single engine is for example situated on the master vibrator. It is naturally bigger than the power unit that is normally fitted individually to each of the vibrators, since it is suitable for a plurality of vibrators composing the train of mobile platforms.

In the context of this particular embodiment of the invention, it can be easily understood that it is not necessary for the slave vibrators, that is to say the vibrators that are not the master vibrator, to have their own motorization.

A train of unmotorized mobile platforms may thus be made up, in which only the master vibrator, for example the vibrator leading the train, is fitted with an internal combustion engine capable of providing the motorization of the train of vibrators and the driving of the vibrator plates.

The mechanical connection between two vibrator trucks is fixed and rigid in the horizontal plane and retains a slight vertical movement.

FIGS. 5, 6 and 7 illustrate a possible embodiment of the mechanical connection between two vibrator trucks for the formation of a train of vibrator trucks. Said mechanical connection takes place advantageously between the rear chassis 1 of a first vibrator truck and the front chassis 2 of a second vibrator truck, a connecting plate 6 being used to interconnect said rear chassis 1 and front chassis 2 of the two vibrator trucks.

The front chassis 2 of the second vibrator truck comprises a front face 3 on which rails 4, 5 are disposed. Said rails 4, 5 extend substantially vertically on said rear face 3 of the rear chassis 2 of the first vibrator truck and are substantially parallel with one another. Said rails 4, 5 are each furnished with a recess. Said recesses of the rails 4 and 5 are facing one another and the end parts of the substantially rectangular connecting plate 6 may come to be housed therein.

Two plates 10a, 10b furnished with substantially circular openings 17a, 17b pierced through said plates 10a, 10b are disposed on the connecting plate 6. They extend in a plane substantially perpendicular to the plane of the surface of the connecting plate 6. Said plates 10a, 10b are substantially parallel with one another and point in the direction of the rear chassis 1 of the first vibrator truck.

The rear chassis 1 of the first vibrator truck comprises a rear face 7. Two plates 8a, 8b furnished with substantially circular openings 9a, 9b pierced through said plates 8a, 8b are disposed on said rear face 7. They extend in a plane substantially perpendicular to the plane of said rear face 7 of said rear chassis 1 of the first vibrator truck. Said plates 8a, 8b are substantially parallel with one another and point in the direction of the front chassis 2 of the second vibrator truck.

Each of said plates 8a, 8b comes respectively to rest against the lateral face of each of said plates 10a, 10b which is positioned toward the outside of said mechanical connection. A first substantially cylindrical piece 18a is inserted into the circular openings 9a, 17a provided respectively on the plates 8a and 10a. A second substantially cylindrical piece 18b is inserted in the circular openings 9b, 17b provided respectively on the plates 8b and 10b. Said first cylindrical piece 18a and second cylindrical piece 18b are thus used to couple the connecting plate 6 and the rear chassis 1 while giving them a degree of freedom, said rear chassis 1 being able effectively to rotate about the axis passing through the circular openings 9a, 17a, 17b, 9b. Evidently, a single cylindrical piece could be used instead of said first cylindrical piece 18a and second cylindrical piece 18b to be inserted both in the circular openings 19a, 17a provided respectively on the plate 8a and 9a and into the circular openings 9b, 17b provided respectively on the plates 8b and 9b.

FIG. 6 represents a schematic side view of the mechanical connection between two vibrator trucks according to the embodiment described hereinabove. This view shows the rotary movement allowed about the coupling axis of the rear chassis 1 to the connecting plate 6 and passing through the circular openings 9a, 17a, 17b, 9b. In this way, the train of vibrator trucks consisting of at least two vibrator trucks thus connected may be used to conduct a geophysical data acquisition campaign on land that is not perfectly flat. FIG. 2 illustrates this situation: two vibrator trucks connected to form a train of vibrator trucks are resting on planes of different inclination. The mechanical connection between said two vibrator trucks offer a degree of freedom sufficient to allow a slight vertical movement of one vibrator truck relative to the other.

Advantageously, and as shown in FIG. 3, the recesses of the rails 4, 5 are substantially crescent-shaped and the end parts of the connecting plate 6 each have advantageously at least two circular parts disposed on the face of the connecting plate 6 situated on the side of the rear chassis of the first vibrator truck. Said circular parts are movable and capable of coming to roll in said recesses of said rails 4, 5. In this way, and as illustrated in FIG. 7, the connecting plate 6 has a see-saw movement about the horizontal axis. Combined with the vertical movement illustrated by FIG. 6 and previously discussed, this see-saw movement creates a mechanical connection between two vibrator trucks according to a structure whose tolerance to the torsional forces is further enhanced. Such a mechanical connection between two vibrator trucks is thus particularly suitable for conducting acquisition campaigns on uneven ground.

Naturally, the structure of the mechanical connection linking two successive vibrator trucks in the train of vibrator trucks is not limited to the possible embodiment of said previously explained connection.

Said connection may also, not limitingly, consist of several drawbars sufficiently robust to pull several vibrator trucks. FIG. 3 illustrates schematically such a connection for which two drawbars are used for connecting the first vibrator truck 31 to the second vibrator truck 34 via respectively their rear and front chassis.

Said connection may also be of the triangular hitch tongue type, as shown schematically in FIG. 4. Such a connection allows, in addition to the vertical movement, a horizontal movement offering a turning angle between two vehicles in line astern. Such a turning angle further minimizes the spacing between the vibrator plates of the various vibrator trucks, as may be seen by comparing FIGS. 3 and 4.

Said connection may also advantageously consist of a more complex system furnished with cylinders. The hydraulic circuits present on each of the vibrator trucks are then used to control said cylinders and allow the connection between the vibrator trucks to be flexible enough for use on uneven ground.

The vibrator trucks of a train of vibrator trucks may, quite clearly, be uncompleted by removing the mechanical connections interconnecting them. Said connections are effectively capable of being easily installed or removed in order to configure the “size” of the train of vibrator trucks particularly to best suit the land being studied and in order to make the vibrator trucks independent of one another again, particularly for their storage, their transport or a conventional use for the acquisition of geophysical data.

Naturally, the invention is not limited to the particular embodiments that have just been described, but extends to any variant complying with the spirit thereof.

1. A mobile device for emitting seismic vibrations in the ground for the purpose of acquiring geophysical data comprising at least two mobile platforms 11, 14, said mobile platforms 11, 14 each comprising a vibrator plate capable of vibrating for the propagation of seismic waves in the ground when said vibrator plate is placed in contact with the ground at a desired stationing point, characterized in that said mobile platforms 11, 14 are interconnected for the formation of a train of platforms in which the distance between the vibrator plates of said mobile platforms 11, 14 is controlled.

2. The device as claimed in claim 1, characterized in that the formation of said train of platforms is achieved by mechanically connecting the rear 13 of one mobile platform 11 to the front 15 of another mobile platform 14, said mobile platforms 11, 14 being thus stationed in line one after the other in said train of platforms.

3. The device as claimed in claim 2, characterized in that it requires a single operator to drive it, said single operator being the driver of the mobile platform at the head of said train of platforms.

4. The device as claimed in claim 3, characterized in that a mechanical and electronic control is carried out remotely by the driver of the mobile platform leading the train on the platforms of said train downstream of said leading platform.

5. The device as claimed in claim 4, characterized in that analogue or digital cables connect the platforms forming the train of platforms for the transmission of the control information between the leading platform of said train and the platforms of said train downstream of said leading platform.

6. The device as claimed in one of claims 2 to 5, characterized in that each of the mobile platforms of said train has its own power unit suitable for providing its motorization and the driving of its vibrator plate.

7. The device as claimed in one of claims 2 to 5, characterized in that the mobile platform leading said train has an engine capable of providing the motorization of the train of platforms and the driving of the vibrator plates, each of the mobile platforms other than that leading the train not requiring its own power unit.

8. The device as claimed in one of claims 2 to 7, characterized in that the mechanical connection linking the rear 23 of a first mobile platform 21 to the front 25 of a second mobile platform 24 is fixed and rigid in the horizontal plane and has a slight vertical movement.

9. The device as claimed in claim 8, characterized in that said mechanical connection comprises a connecting plate 6 which is inserted between the rear part 1 of said first platform and the front part 2 of said second platform, said connecting plate 6 being suitable for allowing a see-saw movement of said first and second platforms about the horizontal axis.

10. The device as claimed in claim 8, characterized in that said mechanical connection comprises at least one drawbar extending between the rear 33 of a first mobile platform 31 and the front 35 of a second mobile platform 34.

11. The device as claimed in claim 8, characterized in that said mechanical connection comprises a triangular hitch tongue allowing a horizontal movement and defining thereby a turning angle between two successive mobile platforms 41, 44 of the train of platforms.

12. The device as claimed in one of claims 8 to 11, characterized in that said mechanical connection is short so as to minimize the spacing between the vibrator plates of the platforms forming said train of platforms.

13. A method of emitting seismic vibrations into the ground in order to acquire geophysical data with the aid of at least two mobile platforms, said mobile platforms each comprising a vibrator plate capable of vibrating for the propagation of seismic waves in the ground when said vibrator plate is placed in contact with the ground, characterized in that it comprises the steps consisting of:
a. interconnecting at least two mobile platforms for the formation of a train of mobile platforms;
b. driving said train of platforms to a desired stationing point;
c. lowering the vibrator plates to place them in contact with the ground, the weight of said platforms pressing on said vibrator plates;
d. making the vibrator plates 2 vibrate so that they transmit seismic waves into the ground;
e. raising the vibrator plates;
f. repeating steps b to e as many times as necessary for the geophysical characterization of the subsurface being studied.
